(19) United States
(12) Patent Application Publication
(10) Pub. No.: US 2024/0348279 A1
(43) Pub. Date: Oct. 17, 2024

(54) TRANSCEIVER INTERFACE, TRANSCEIVER SYSTEM AND METHOD FOR OPERATING A TRANSCEIVER INTERFACE

(71) Applicant: FLEXOPTIX GMBH, Darmstadt (DE)

(72) Inventors: David Elias ÖNAL, Darmstadt (DE); Thomas WEIBLE, Darmstadt (DE); Markus ARNOLD, Darmstadt (DE)

(73) Assignee: FLEXOPTIX GMBH, Darmstadt (DE)

(21) Appl. No.: 18/579,297

(22) PCT Filed: Jul. 19, 2022
(86) PCT No.: PCT/EP2022/070113

§ 371 Date: Jan. 12, 2024

(30) Foreign Application Priority Data
Jul. 26, 2021 (DE) 10 2021 119 318.4

(51) Int. Cl. H04B 1/40; H04M 1/02

(52) U.S. Cl. CPC H04B 1/40; H04M 1/0274

(57) ABSTRACT

The invention relates to a transceiver interface, in particular a mobile transceiver interface, comprising a configuration unit for configuring a pluggable transceiver, which comprises a communication interface for communication with an external unit and a transceiver interface for communication with the transceiver. In order to provide a generic device having improved properties in terms of flexibility, it is proposed that the transceiver interface comprises a power supply unit for the autonomous power supply of at least the configuration unit.

### PRIOR ART

The invention relates to a transceiver interface according to the preamble of Claim 1, a transceiver system according to Claim 15 and a method for operating a transceiver interface according to the preamble of Claim 16.

From the prior art, for example from the unexamined application DE102016115546 A1, a transceiver interface for programming a transceiver is already known, wherein an external power supply source supplies the transceiver interface with power based on programming of the transceiver.

The object of the invention is in particular to provide a generic device which has improved properties with regard to flexibility. The object is achieved according to the invention by the features of Claims 1, 15 and 16, while advantageous embodiments and further developments of the invention can be derived from the subclaims.

### Advantages of the Invention

The invention relates to a transceiver interface, in particular a mobile transceiver interface, having a configuration unit for configuring a pluggable transceiver which comprises a communication interface for communication with an external unit and a transceiver interface for communication with the transceiver.

It is proposed that the transceiver interface has a power supply unit for the autonomous power supply of at least the configuration unit. Such a design can provide a high degree of flexibility. In particular, an advantageous mobility and/or a particularly flexible deployment of a transceiver interface can be achieved by means of an autonomous power supply of at least one configuration unit. In addition, the versatility of the transceiver interface can be increased, particularly with respect to its use and/or with respect to a communication link to at least one transceiver and/or at least one external unit. The transceiver interface can thus be used universally in any type of system, in particular optical systems. In addition, a very compact transceiver interface can be provided, which in turn allows the storage and transport of the transceiver interface to be significantly optimized. In addition, efficiency can be improved, advantageously with regard to performance efficiency and/or product efficiency. By means of a power supply unit, an autonomous power supply of at least the transceiver interface is possible, so that an external power supply source for operating the transceiver interface, and advantageously for configuring the transceiver by means of the transceiver interface, can preferably be omitted. In addition, if configuration is performed via a browser, in particular by means of the external unit, it may be possible to omit the installation of a special program and/or a special application of the transceiver interface. It is conceivable that, by means of the power supply unit, a preferably wireless communication link could be provided between the external unit and the transceiver interface, in particular a configuration unit.

In the present case, a transceiver interface is provided which can supply itself with power independently by means of the power supply unit in at least one operating state. During configuration of the transceiver, the power supply unit is designed to autonomously supply at least the transceiver interface with power. The autonomous power supply by means of the power supply unit is preferably specifically independent of an external power supply source, for example the external unit.

The transceiver interface can be part of a transceiver system. The transceiver system, in particular an optical transceiver system, is advantageously designed for configuring and/or reconfiguring at least one transceiver. The transceiver system can be designed for carrying out a test operation, in particular for testing the transceiver, and/or for carrying out a measurement operation, in particular for measuring and/or calibrating the transceiver and/or for measuring and/or calibrating another object by means of the transceiver. Preferably, the external unit and/or the transceiver is part of the transceiver system. The transceiver system could be, for example, an SFP, in particular an SFP-DD, SFP+, SFP28 and/or cSFP, and/or a CFP, in particular, a CFP2, CFP4 and/or CFP8, and/or a QSFP, in particular a QSFP+, QSFP14, QSFP28, QSFP56, and/or QSFP-DD, and/or an XFP and/or OSFP transceiver system. The transceiver system could provide at least one data transmission system and/or a communication system for the external unit, the transceiver interface and/or at least the transceiver.

The transceiver could be an electrical, in particular an electrical-electrical, transceiver or preferably an optical, in particular an optical-electrical, transceiver (OT). If an optical transceiver is used, the transceiver is preferably designed to provide an optical-electrical receiving device and an electrical-optical transmitting device. The optical transceiver could receive at least optical signals from at least one data transmission unit, in particular a fiber, such as an optical fiber, and/or convert the optical signals at least into electrical signals. The transceiver is a plug-in transceiver, in particular a pluggable transceiver. The transceiver could be, for example, an SFP, in particular an SFP-DD, SFP+, SFP28 and/or cSFP, a CFP, in particular a CFP2, CFP4 or CFP8, a QSFP, in particular a QSFP+, QSFP14, QSFP28, QSFP56 or QSFP-DD, an OSFP or an XFP transceiver. The transceiver could be designed for arrangement, in particular for connection to, and/or for communication with a power sourcing equipment (PSE) device, wherein the PSE could be, for example, a router and/or a hub and/or advantageously a switch.

The transceiver could be connectable to the transceiver interface in a reversible, in particular releasable, and preferably non-destructively releasable manner, and preferably able to be plugged into the transceiver interface. The transceiver interface could comprise at least one wire-bound transceiver communication unit, advantageously at least one transceiver slot, for wire-bound communication with the transceiver. In a method for operating the transceiver interface, the transceiver can be connected to the transceiver interface. Preferably, the transceiver is plugged into the transceiver communication unit, in particular the transceiver slot. The transceiver communication unit, advantageously the transceiver slot, advantageously at least partially receives the transceiver in at least one connected state, in particular a plugged-in state. In the plugged-in state, the transceiver can communicate with the transceiver interface via the transceiver interface. In an unconnected state, at least the transceiver is arranged separately from the transceiver interface.

The transceiver interface is in particular an electrical and/or electronic and preferably mobile device, which is designed for the configuration and/or reconfiguration of the transceiver. The configuration should be advantageously understood here to mean programming, in particular reprogramming, of the transceiver, preferably an encoding and/or an identifier of the transceiver. Alternatively and/or additionally, the configuration of the transceiver, in particular by means of the configuration unit, could comprise performing a tuning and/or a test operation, in particular a tuning and/or a test of the transceiver, and/or performing a measurement, in particular for measuring and/or calibrating the transceiver, and/or measuring and/or calibrating another object by means of the transceiver. The tuning could be, in particular, a wavelength tuning. In the method for operating the transceiver interface, the transceiver can be configured, in particular programmed and/or tuned and/or tested. Advantageously, the configuration unit changes the configuration, in particular the encoding and/or the identifier, of the transceiver. The configuration unit could modify, recode, reprogram and/or adapt the configuration of the transceiver, in particular to different hardware types and/or hardware configurations, to advantageously enable the use of the transceiver with different hardware, such as from different hardware manufacturers. Preferably, the transceiver is configured to allow the use of the transceiver with different PSEs, in particular by different hardware manufacturers. Preferably, the configuration unit is designed for changing the configuration of the transceiver multiple times and/or repeatedly. In particular, the power supply unit is designed for enabling the configuration of the transceiver by means of the configuration unit in at least the operating state, and preferably independently of the external power supply source, for example, the external unit.

The transceiver interface may potentially be a stationary device. Preferably, the transceiver interface is implemented as a mobile device, in particular as a handheld and/or a hand-held unit. The transceiver interface is advantageously an electrical and/or electronic interface, in particular connection interface, which could be designed for, in particular electrical, connection to the transceiver, in particular by means of at least the transceiver slot. In the plugged-in state, the transceiver can communicate with the configuration unit via the transceiver interface, in particular by means of the wire-bound transceiver communication unit, preferably by means of the transceiver slot. The transceiver interface, in particular the wire-bound transceiver communication unit, could have a plurality, in particular at least two and/or at least three, transceiver slots, which are designed in particular for the optional and/or simultaneous connection of at least the transceiver and advantageously at least one further transceiver.

The transceiver interface, preferably the wire-bound transceiver communication unit, may have at least one advantageously standardized transceiver contact element, in particular transceiver plug connector element and advantageously built-in plug connector element, in particular assigned to the transceiver slot, which is provided for, in particular electrical, contacting with the transceiver. Preferably, the transceiver communication unit comprises a plurality of transceiver contact elements, wherein advantageously each transceiver slot is assigned exactly one of the transceiver contact elements. In this context, a standardized object is intended advantageously to be an object which has at least partially standardized dimensions, in particular external dimensions, and/or an at least partially standardized shape. The transceiver interface, in particular the wire-bound transceiver communication unit, could provide the communication with the transceiver at data transmission rates of at least 0.1 Gbit/s, in particular at least 1 Gbit/s, advantageously at least 10 Gbit/s, in particular at least 40 Gbit/s, preferably at least 100 Gbit/s and particularly preferably at least 800 Gbit/s.

In the method for operating the transceiver interface, the transceiver is preferably configured by means of the external unit. In the operating state, the transceiver interface could receive a configuration command from the external unit for configuring the transceiver. The external unit is in particular an electronic external device, preferably designed as an operating unit and/or control unit, which is designed in particular for operating and/or controlling the transceiver interface, and preferably for configuring the transceiver. The external unit can be a terminal device, advantageously a mobile device. The external unit could be, for example, a computer, in particular a permanently installed one, and/or a laptop and/or a convertible and/or a mobile phone, in particular smartphone, and/or a tablet and/or a phablet and/or a personal digital assistant (PDA) and/or an equivalent electronic device and/or a special application for controlling the transceiver interface and/or for configuring the transceiver. The operation and/or control of the transceiver interface and/or the configuration of the transceiver may possibly take place directly by means of a browser, in particular one that is executable on the external unit.

The external unit could communicate via the communication interface with the transceiver interface, preferably with the configuration unit, in the operating state. The communication interface can transmit at least the configuration command and/or a control command for configuring the transceiver from the external unit at least to the configuration unit of the transceiver interface. By means of the transceiver interface and/or the communication interface, the configuration unit configures the transceiver depending on the configuration command in the operating state. Preferably, the configuration unit changes the encoding and/or identifier of the transceiver depending on the configuration command. It would also be conceivable for the configuration unit to perform the tuning and/or testing of the transceiver depending on the configuration command.

The operating state could be a normal operating state. In the normal operating state, the configuration unit could configure the transceiver, advantageously program and/or reprogram it. In particular, the configuration unit changes the encoding and/or identifier of the transceiver in the normal operating state. Alternatively, at least the transceiver interface could be in a test operating state. In the test operating state, the transceiver could be tuned and/or tested by means of the configuration unit. Preferably, at least one line parameter, preferably of the transceiver, can be tested in the test operating state by means of the configuration unit. For example, an optical tape of the transceiver could be able to be scanned and/or tested in at least the test operating state. Alternatively and/or additionally, a connection to the fiber and/or a line parameter of the fiber, in particular the optical fiber, could be testable via the transceiver. In particular, the operating state comprises the normal operating state and/or the test operating state.

The operating state, in particular the normal operating state and/or the test operating state, could have at least one operating mode, in particular a plurality of operating modes. It is conceivable that in the operating state, in particular in at least one first operating mode, the power supply to at least the configuration unit could be provided by means of the external power supply source. The external unit could provide the external power supply source for supplying power at least to the configuration unit. Preferably, the transceiver interface can be operated independently of the external power supply source. In the operating state, preferably in a second operating mode and/or at least a third operating mode, the transceiver interface could be autonomously operable by means of the power supply unit independently of the external power supply source. In the second operating mode and/or at least the third operating mode, the power supply unit can provide an autonomous supply of power, in particular independently of the external unit, at least to the configuration unit. For example, the power supply unit could comprise a battery and/or a rechargeable battery. In particular, the power supply unit is a unit for receiving, storing and/or delivering electrical power. The power supply unit may be replaceable and/or rechargeable. It is conceivable that the power supply unit is charged as part of the method for operating the transceiver interface. In at least one operating mode, in particular the first operating mode, the external unit could charge the power supply unit by means of the communication interface.

The term “designed” is to be understood here and in the following to mean specifically programmed, configured and/or equipped. The fact that an object is designed for a specific function, is intended to mean that the object fulfils and/or performs this specific function in at least one application state and/or operating state.

Furthermore, it is proposed that the power supply unit provides an autonomous power supply of at least the configuration unit for at least 30 minutes in the operating state. This provides a high degree of flexibility for an operator, which is advantageous to the extent that a power supply for different operating modes in an operating state can be provided. By means of the power supply unit, a sufficiently long autonomous power supply, namely a power supply independent of an external power supply source, can be provided for at least a configuration, namely advantageously a programming and/or a reprogramming and/or a test measurement and/or a tuning of a transceiver. This can also increase efficiency and convenience, in particular user-friendliness.

It would be conceivable for the power supply unit to provide an autonomous power supply of at least the configuration unit for at least 5 hours in the normal operating state, advantageously for at least 7 hours and particularly preferably for at least 8 hours. In the test operating state, the power supply unit could provide an autonomous power supply of at least the configuration unit for at least 40 minutes, advantageously for at least 60 minutes and particularly preferably for at least 90 minutes. Possibly, at least one laser unit of the configuration unit can be switched on in the test operating state for tuning and/or testing at least the transceiver. The power supply unit can autonomously supply at least the laser unit with power.

In order to provide a particularly flexible and/or versatile transceiver interface, it is proposed that the communication interface comprises a wireless communication unit, in particular a WPAN communication unit, for wireless communication with the external unit. This also allows a more flexible and versatile communication link to be provided between the transceiver interface and the external unit. In addition, the wireless communication unit may make it possible to omit a wire-bound communication unit between the transceiver interface and the external unit. This can also achieve an advantageously simple and/or fast communication and/or means of connection, namely also to, in particular mobile, external units, which have either no or only special ports, such as Lightning® ports.

The wireless communication unit can provide a wireless communication link, in particular a wireless data link, between the transceiver interface and at least the external unit. For example, the wireless communication unit could be a Wireless Local Area Network communication unit, or WLAN communication unit. Preferably, the wireless communication unit is implemented as a Wireless Personal Area Network communication unit, namely the WPAN communication unit. For example, to establish a communication link from the transceiver interface to at least the external unit, the wireless communication unit could provide, for example, an infrared connection, a WLAN connection, a radio connection, an NFC connection, a wireless USB connection, a ZigBee connection and/or preferably a Bluetooth connection. The wireless communication unit could provide the wireless communication link between the transceiver interface and at least the external unit at a distance from the transceiver interface to the external unit of not more than 100 m, advantageously not more than 10 m, preferably not more than 1 m, and preferably not more than 10 cm. By means of the WPAN communication unit, the wireless communication link can be provided at a distance from the external unit to the transceiver interface of not more than 50 m, advantageously not more than 10 m, preferably not more than 50 cm and particularly preferably not more than 10 cm. Preferably, the transceiver interface communicates with the external unit using Bluetooth Low Energy (BLE). In particular, the wireless communication unit, preferably the WPAN communication unit, communicates with the external unit by means of BLE. The wireless communication unit could comprise a BR/EDR controller and/or LE controller. The Bluetooth connection can be a BLE connection, such as a BLE 4.0 connection and/or a BLE 5.0 connection and/or a higher connection.

The wireless communication link is optionally switchable on and off. It would be conceivable for the transceiver interface to have an operating element which is designed for activating at least the wireless communication link between the external unit and the transceiver interface. By means of the operating element, an operator can switch between the operating modes in the operating state, in particular the first operating mode and/or the second operating mode and/or at least the third operating mode. The operating element can be movable between at least three positions, the three positions being in particular assigned to at least the three operating modes. In at least the third operating mode, the wireless communication unit could provide the wireless link for communication between the transceiver interface and at least the external unit.

By means of the transceiver interface, the configuration unit could communicate with the transceiver in a low-speed mode and/or a high-speed mode. In particular, the transceiver has a low-speed interface and/or a high-speed interface. During configuration, in particular during programming and/or tuning of the transceiver, the configuration unit could communicate with the low-speed interface of the transceiver, advantageously in the low-speed mode. The transceiver interface could provide at least one configuration connection to the transceiver, in particular with the low-speed interface.

If the transceiver interface is designed to provide a user data connection to the transceiver, flexibility and convenience can be further enhanced. This means that a user can not only configure a transceiver by means of the transceiver interface, but can also use a user data connection, for example an Internet connection, by means of the transceiver. Preferably, the configuration unit communicates with the transceiver in the high-speed mode, advantageously by means of the high-speed interface. The user data connection may be an Internet connection, in particular a high-speed Internet connection, and/or a LAN connection.

If the communication interface has at least one wire-bound communication unit, preferably a USB communication unit, for wire-bound communication with the external unit, a particularly convenient, advantageously stable, communication link can be provided between the external unit and the transceiver interface. In addition, flexibility with regard to the communication with the external unit can be increased, since in addition to further communication options, for example by means of a wireless communication unit, a communication interface can also preferably comprise a wire-bound communication unit. In addition, the wire-bound communication unit may make it possible to omit the wireless communication unit for wireless communication between the transceiver interface and the external unit. Furthermore, it would be conceivable to use the wire-bound communication unit to preferably provide communication with external units which have special ports, such as Lightning® ports.

The wire-bound communication unit preferably forms a wire-bound connection interface, in particular a wire-bound data interface between the transceiver interface and at least the external unit. The wire-bound communication unit, in particular the USB communication unit, can be implemented, for example, as a type-A plug, type-B plug, type-C plug, mini-plug, mini A-plug, mini-B plug, micro-plug, micro-A plug and/or micro-B plug and/or advantageously as a type-A socket, type-C socket, mini-socket, mini-AB socket, mini-B socket, micro socket, micro-AB socket, micro-B socket, and/or preferably as a USB-C communication unit. Preferably, the USB-C communication unit is a USB-C socket, into which a USB-C plug of the external unit can be inserted. In the operating mode, the configuration of the transceiver by means of the external unit can be carried out via at least the wire-bound communication unit. Advantageously, in the method for operating the transceiver interface, the external unit is connected by means of the wire-bound communication unit to the transceiver interface, in particular the configuration unit. In the plugged-in state, the external unit can be connected to the transceiver interface by means of the wire-bound communication unit. Preferably, the communication, in particular the data transmission, between the external unit and at least the transceiver interface in the first operating mode and/or at least the second operating mode takes place via the wire-bound communication unit.

It is further proposed that the transceiver interface has a transceiver configuration device, in particular a mobile transceiver configuration device, which comprises at least the transceiver interface and a configuration element of the configuration unit, at least for programming the transceiver. This allows flexibility and convenience to be further increased. In addition, a transceiver can be connected to a transceiver configuration device for configuration. By using a mobile transceiver configuration device, an advantageously compact and/or mobile transceiver interface can also be provided.

The transceiver configuration device is preferably a mobile, in particular portable, transceiver configuration device. The transceiver configuration device may comprise the wire-bound transceiver communication unit, in particular at least the transceiver slot. The transceiver interface, preferably the transceiver configuration device, can have at least two transceiver slots, in particular the transceiver slot and at least the additional transceiver slot, of different design. Objects with different design are to be understood in this context to mean different and/or distinct objects, in particular of the same device type, which differ at least partly in their mode of functioning, their construction, in particular their internal construction and/or their dimensions, in particular in length, width and/or height. The transceiver slot may differ from the additional transceiver slot with regard to a data transfer rate.

The transceiver configuration device could have a device housing. At least the transceiver interface could be arranged in the device housing. The device housing is advantageously configured as an external housing. The device housing could have a holding unit, which is designed for holding the external unit, at least partially. The holding unit may be a surface unit of the device housing, in particular a top wall of the device housing. The external unit could be able to be placed at least partially, and preferably completely, on top of the holding unit. In the method for operating the transceiver interface, the external unit can be placed at least partially on the holding unit. In an arranged state of the external unit, the external unit could be able to be placed on top of the transceiver configuration device, in particular the holding unit, in an amount of at least 10%, advantageously at least 30%, preferably at least 50% and particularly preferably at least 80%. The holding unit is advantageously designed at least substantially flat. In particular, the holding unit has a main extension plane that is at least substantially parallel to a main extension plane of the device housing, wherein an orientation of a plane, in particular the main extension plane of the holding unit, deviates by a maximum of 8°, advantageously by a maximum of 5° and particularly advantageously by a maximum of 1° from an orientation of a reference plane, in particular the main extension plane of the device housing. The main extension plane of an object is to be understood as a plane which is parallel to a largest side face of a smallest, in particular imaginary, cuboid which just completely encloses the object and in particular passes through a center, in particular a geometric center, of the cuboid. The term “at least substantially” is intended to mean here that a value and/or an orientation deviates by a maximum of 10%, advantageously by a maximum of 5% and preferably by a maximum of 1% from the described value and/or the described orientation.

Advantageously, the holding unit is formed at least partially integrally with the device housing, in particular the top wall of the device housing. The term “integral” shall be understood to mean at least materially bonded, for example, by means of an adhesive process, a welding process, an injection process and/or any other process that appears meaningful to a person skilled in the art, and/or to mean shaped in one piece, for example, by manufacturing in a single- or multi-component injection process and/or by manufacturing from a single blank by a casting and/or punching process. Advantageously, integral is also to be understood as single-part. “Single-part” is understood to mean shaped in one piece. Preferably, this single piece is produced from a single blank, compound and/or casting, particularly preferably in an injection molding process, in particular a single- and/or multi-component injection molding process. The device housing and/or the holding unit could be producible at least partially and/or to a large extent by means of a 3D-printing process, by means of a sheet metal bending process, or preferably by means of an injection molding process. The device housing and/or the holding unit could be formed at least partially and/or to a large extent from a plastic and/or a metal and/or a composite material. The term “to a large extent” shall be understood to mean at least 55%, advantageously at least 65%, preferably at least 75%, particularly preferably at least 85% and particularly advantageously not more than 95% of a volume and/or mass component.

The holding unit could have at least one adhesive friction element, which is designed for increasing adhesive friction, in particular in the region of a contact surface with the external unit. The adhesive friction element can be formed as any adhesive friction element, such as, for example, a rough and/or roughened surface element, as a silicone element and/or advantageously as a rubber element, in particular as a rubber mat and/or a rubber coating. Alternatively or in addition, it is conceivable that the holding unit has further holding elements, such as clamping elements and/or magnetic holding elements.

It would be conceivable for the transceiver configuration device to comprise the communication interface. In the operating state the transceiver configuration device can communicate with the external unit at least by means of the communication interface. The transceiver configuration device could comprise the wire-bound communication unit and/or an additional wire-bound communication unit of the communication interface for wire-bound communication with the external unit. The additional wire-bound communication unit could be an additional USB communication unit, similar to the wire-bound communication unit. Preferably, the wire-bound communication unit and the additional wire-bound communication unit are designed identically to each other.

It is further proposed that the power supply unit is additionally designed for the autonomous power supply of at least the configuration element. This can further increase flexibility by enabling the configuration of a transceiver without an additional power supply from an external power supply source, such as an external unit.

The configuration element allows the transceiver to be configured. The configuration element can at least program the transceiver. In addition, the configuration element may be designed at least for tuning and/or at least for testing the transceiver. In the operating state, the configuration element can receive the configuration command and/or the control command from the external unit to configure the transceiver. For example, the configuration element could be a chipset for configuring, in particular for programming and/or tuning and/or testing, the transceiver. Advantageously, the configuration element is controlled directly by means of the browser executable on the external unit, which in particular allows installation of a special program and/or special application to be omitted.

In a preferred embodiment, the transceiver interface has an adapter with an adapter unit, which comprises the communication interface and an adapter interface for communication with the transceiver configuration device. This allows a particularly flexible and convenient transceiver interface to be provided. In addition, a highly versatile range of connection options between external units and the transceiver interface can be obtained, since the adapter can preferably be used to provide communication with external units which have specific ports, namely ones that differ from the transceiver configuration device, such as Lightning® ports.

The adapter is advantageously an accessory and/or retrofit part of the transceiver interface for the transceiver configuration device. The adapter is preferably mobile, in particular portable. In particular, the adapter is provided for communication with at least the transceiver configuration device. The adapter can allow communication between the external unit and the transceiver configuration device.

The adapter can have a longitudinal extension of not more than 200 mm, advantageously not more than 150 mm, preferably not more than 100 mm, and particularly preferably not more than 80 mm. In this context, a “longitudinal extension” of an object is to be understood as an extension of the object in a longitudinal extension direction of the object. The longitudinal extension direction of the object is a direction parallel to a second-longest edge and/or side of an, in particular imaginary, smallest cuboid that just encloses the object.

A transverse extension of the adapter could have a maximum of 120 mm, preferably a maximum of 60 mm, preferably a maximum of 40 mm and, particularly preferably, a maximum of 30 mm. In this context, a “transverse extension” of an object is to be understood as an extension of the object in a transverse extension direction of the object. The transverse extension direction of the object is a direction parallel to a second-longest edge and/or side of an in particular imaginary, smallest cuboid that just encloses the object.

Advantageously, the adapter, in particular an outer housing of the adapter, is at least substantially cuboidal in shape. Particularly advantageously, the adapter has a thickness of not more than 80 mm, advantageously not more than 40 mm, preferably not more than 30 mm and particularly preferably not more than 20 mm.

The adapter and/or the transceiver configuration device can at least partially comprise the configuration unit. In particular, the configuration unit is at least partially designed integrally, preferably as a single part, with the adapter and/or the transceiver configuration device. The adapter and/or the transceiver configuration device can comprise at least one unit and/or at least one element of the configuration unit. Preferably, the adapter and the transceiver configuration device jointly comprise the configuration unit. It is possible for the transceiver configuration device and/or the adapter to comprise the entire configuration unit.

In particular, the adapter unit is part of the configuration unit. The adapter unit advantageously comprises the communication interface. In the operating state, the communication interface can establish communication between the external unit and at least the adapter. In particular, the communication link exists between the external unit and the configuration unit, by means of the communication interface via the adapter. The communication interface can communicate with the external unit by means of a first communication protocol.

The adapter interface is preferably part of the configuration unit. By means of the adapter interface, in the plugged-in state and in the operating state the adapter can communicate with the transceiver configuration device by means of a second communication protocol.

The adapter unit could comprise a converter unit. The converter unit is designed for converting between the first communication protocol and the second communication protocol. In particular, the converter unit converts communication by means of the first communication protocol or the second communication protocol into communication by means of the second communication protocol or the first communication protocol. The converter unit may be designed to enable communication between the external unit and at least the adapter and/or the transceiver configuration device. It is conceivable that in the method for operating the transceiver interface, the first communication protocol could be converted into the second communication protocol and vice versa.

It would be conceivable for the adapter to communicate with the transceiver configuration device in the operating state via a wireless adapter communication unit of the adapter unit. The adapter interface preferably comprises at least one wire-bound adapter communication unit, in particular a USB adapter communication unit, for wire-bound communication with the transceiver configuration device. This means that a particularly convenient transceiver interface can be provided, since an advantageously stable communication link between the transceiver configuration device and the adapter can be provided by means of the wire-bound adapter interface. In addition, flexibility with regard to a communication link between the transceiver configuration device and the adapter can be further increased.

The wire-bound adapter communication unit preferably forms a wire-bound connection interface, in particular a wire-bound data interface, between the transceiver configuration device and at least the adapter. In the operating mode, the adapter can communicate with the transceiver configuration device via the wire-bound adapter communication unit. Preferably, the communication, in particular the data transmission, between the external unit and at least the transceiver configuration device in the first operating mode and/or at least the second operating mode takes place via the wire-bound adapter communication unit. The external unit can transmit at least the configuration command to the transceiver configuration device, in particular the configuration element, via the wire-bound adapter communication unit. The adapter could be permanently connected to the transceiver configuration device by means of the wire-bound adapter communication unit. Preferably, the adapter can be connected to the transceiver configuration device in a reversible, in particular releasable, and preferably non-destructively releasable manner, and is preferably able to be plugged into the transceiver interface. In the plugged-in state, the wire-bound adapter communication unit is connected to the transceiver configuration device.

In order to provide a particularly stable, efficient and flexible communication link between a transceiver configuration device and an adapter, it is proposed that the wire-bound adapter communication unit has a plug connector element which can be directly connected to the transceiver configuration device. This means that both flexibility and convenience can be further increased, namely due to the fact that the adapter can be connected easily and quickly by means of a connector element, advantageously reversibly, to the transceiver configuration device if required. This can also ensure a secure and/or stable mounting and/or connection of the adapter to the transceiver configuration device. In the case of a direct connection by means of the plug connector element, a lead, in particular a cable and/or a conductor track, between the adapter and the transceiver configuration device can also preferably be omitted.

Preferably, the adapter can be connected to the transceiver configuration device in a reversible, in particular releasable, and preferably non-destructively releasable manner, namely being preferably able to be plugged into the transceiver configuration device. In the plugged-in state, the adapter is connected to the transceiver configuration device by means of the plug connector element directly, preferably wirelessly.

The wire-bound adapter communication unit, in particular the USB adapter communication unit, can be implemented, for example, as a type-A plug, type-B plug, type-C plug, mini-plug, mini A-plug, mini-B plug, micro-plug, micro-A plug and/or micro-B plug and/or advantageously as a type-A socket, type-C socket, mini-socket, mini-AB socket, mini-B socket, micro socket, micro-AB socket, micro-B socket, and/or preferably as a micro-USB adapter communication unit. Preferably, the wire-bound adapter communication unit, in particular the plug connector element, is a micro-USB plug which can be plugged into a mating socket of the transceiver configuration device. The mating socket is preferably a micro-USB mating socket. The mating socket of the transceiver configuration device is preferably recessed in the device housing. Advantageously, in the method for operating the transceiver interface, the wire-bound adapter communication unit, preferably the plug connector element, is plugged into the transceiver configuration device.

In a possible embodiment, the transceiver configuration device can comprise the power supply unit for the autonomous power supply at least of the configuration unit, in particular of at least the configuration element.

In a preferred embodiment, it is proposed that the adapter comprises the power supply unit for the autonomous power supply of at least the adapter unit. This can further enhance the flexibility and versatility of a transceiver interface. In addition, the power supply unit can be connected to a transceiver configuration device flexibly by means of an adapter if required. This allows a particularly compact transceiver configuration device to be provided. In addition, the efficiency with regard to power and/or energy efficiency can be increased, since the power supply unit can be connected to the transceiver configuration device only when required to provide the autonomous power supply, preferably for configuring a transceiver. Advantageously, in the method for operating the transceiver interface the adapter unit is supplied with power. In the operating state, the power supply unit can at least supply the adapter unit with power autonomously in order to preferably provide the communication link, in particular the wireless communication link, between the transceiver interface, in particular the adapter, and the external unit by means of the wireless communication unit, in particular the WPAN communication unit. By means of the adapter, the power supply unit could be flexibly connectable to the transceiver configuration device, in particular if the operator requires it.

In order to increase flexibility and convenience even further, it is proposed that the power supply unit is additionally designed to provide the autonomous power supply of at least the external unit. Thus, the external unit, for example a mobile phone and/or a tablet, can be supplied with power and preferably charged in an operating state, and advantageously during the configuration of the transceiver. In the operating state, the power supply unit could additionally supply the external unit with power. Advantageously, in the method for operating the transceiver interface the external unit is supplied with power. In particular, the external unit, for example, the mobile phone and/or the tablet, can be charged by means of the power supply unit in the operating state.

It is further proposed that the configuration unit has a display unit which is designed for displaying at least an operating status and/or an operating mode. This can increase convenience with regard to user-friendliness. In addition, a high flexibility of a transceiver interface can be provided, because the display unit can display different operating states and/or operating modes of the transceiver interface.

The display unit could be part of the transceiver configuration device and/or preferably part of the adapter. Preferably, the adapter housing, in particular the operating element, comprises the display unit. It would be conceivable that the display unit comprises a light source, for example a light-emitting diode (LED), an organic light-emitting diode (OLED) and/or electronic paper (e-paper, ePaper). Preferably, the display unit, in particular the light source, provides an RGB color system. In the operating state, the power supply unit can autonomously supply at least the display unit with power. In addition, it would be conceivable for the configuration unit to have an acoustic output unit for the acoustic output of at least one signal to the operator.

In the operating state the display unit can display an operating status with regard to at least one operating mode of the operating modes, in particular the first operating mode and/or the second operating mode and/or at least the third operating mode. The display unit could potentially display the operating status and/or operating mode using different colors. For example, the display unit could emit yellow light in the first operating mode and/or blue light in the second operating mode and/or green light in the third operating mode. With regard to the operating status, the display unit could flash and/or remain continuously lit during the operating state. The operating state could be, for example, a state in which the transceiver interface searches for a communication link with the external unit, in particular by means of the wireless communication unit, and/or attempts to establish the same. The display unit, in particular the light source, could flash when the transceiver interface is not connected to the external unit. If the communication link exists, in particular the wireless communication link and/or the wire-bound communication link, between the transceiver interface and the external unit, the display unit could indicate this operating status by means of a permanently illuminated display, in particular a permanent illumination of at least the light source.

In the first operating mode, for communication with the transceiver interface the external unit may be connected by means of the wire-bound communication unit to the transceiver interface, in particular to the adapter and/or the transceiver configuration device. The data transmission and/or communication between the external unit and the transceiver interface can be wire-bound, in particular passive. In addition, in the first operating mode the external unit can at least supply the configuration unit with power, in particular by means of the wire-bound communication unit. For example, the display unit could indicate the first operating mode using yellow light.

For example, the display unit could indicate the second operating mode using blue light. In the second operating mode, for communication with the transceiver interface, in particular the configuration unit, the external unit is preferably connected via the wire-bound communication unit. In the second operating mode, the power supply unit can provide an autonomous power supply, in particular independently of the external unit, of at least the configuration unit.

To distinguish the third operating mode from at least the first operating mode and/or the second operating mode, the display unit could light up green in the third operating mode. In at least the third operating mode, the power supply unit can provide an autonomous power supply of at least the configuration unit. This allows the wireless communication unit to provide the wireless link for communication between the transceiver interface and the external unit in at least the third operating mode. Preferably, in the third operating mode the external unit is connected to the transceiver interface, in particular to the adapter and/or the transceiver configuration device, by means of the Bluetooth connection.

To further increase flexibility, the transceiver interface has an operator interface for operating and/or controlling the configuration unit. In addition, an internal, in particular autonomous, control and/or operation of the transceiver interface can thereby be provided, and configuration of a transceiver and/or control of the transceiver interface by means of an external unit can be omitted. Furthermore, this can increase convenience with regard to user-friendliness. In this operating state, the transceiver could be configured by means of a configuration command from the operator interface. The operator could control and/or adjust the configuration of the transceiver via the operator interface, in particular configure the transceiver. In particular, the operator interface allows operation of at least the configuration unit, in particular the configuration element, for the operator. A special program and/or special application could be installed on the configuration element to configure the transceiver.

In addition, the invention is based on a method for operating a transceiver interface, in particular an aforementioned transceiver interface, having an external unit, in particular the aforementioned external unit, for controlling the transceiver interface, wherein the transceiver interface has a configuration unit for configuring a transceiver with a communication interface for communication with the external unit.

It is proposed that at least the configuration unit is autonomously supplied with power. Such a method can advantageously provide particularly high flexibility in the operation of a transceiver interface. In particular, an advantageous mobility and/or a particularly flexible deployment of the transceiver interface can be achieved by means of an autonomous power supply of at least a configuration unit of the transceiver interface. In addition, the versatility of the transceiver interface can be increased, particularly with respect to its use and/or with respect to a communication link to at least one transceiver and/or at least one external unit.

It is also proposed that the communication interface has a WPAN communication unit for wireless communication with the external unit and that the external unit is placed at least partially on the adapter. This can further increase flexibility and convenience by providing a particularly simple and quick connection between a transceiver interface and an external unit. The external unit is advantageously placed at least partially on the transceiver configuration device and/or the adapter. In the arranged state, the external unit can be at least partially arranged on the transceiver configuration device and/or the adapter. It would be conceivable for the external unit to be placed on the adapter and/or the transceiver configuration device in an amount of at least 5%, advantageously at least 10%, preferably at least 30% and particularly preferably at least 50%.

In this document, ordinal words, such as “first” and “second”, which are placed before certain terms, are used solely to distinguish between method steps and/or objects and/or to assign objects to each other and do not imply the existence of a total number and/or order of precedence of the objects and/or method steps. In particular, a “second” object and/or method step does not necessarily imply the existence of a “first” object and/or method step.

The transceiver interface, the transceiver system and the method for operating a transceiver interface shall not be restricted to the application and embodiment described above. In particular, in order to fulfil a function described herein the transceiver interface and/or the transceiver system and/or the method for operating the transceiver interface may comprise a number of individual elements, components, units and/or method steps that differs from a number specified herein. In addition, with regard to the ranges of values specified in this document, values within the aforementioned limits should also be regarded as disclosed and as usable as desired.

### DRAWINGS

Further advantages are obtained from the following description of the drawings. The drawings illustrate two exemplary embodiments of the invention. The drawings, the description and the claims contain numerous features in combination. The person skilled in the art will also advantageously consider the features individually and combine them to form further meaningful combinations.

Shown are:

FIG. 1 a transceiver system having a transceiver interface, an external unit and at least one transceiver in a plugged-in state,

FIG. 2 the transceiver system with the transceiver interface and at least the transceiver in an unconnected state,

FIG. 3 a detail view of a transceiver interface having a transceiver configuration device and an adapter in the plugged-in state,

FIG. 4 a further detail view of the transceiver interface in accordance with FIG. 3,

FIG. 5 a detail view of the transceiver configuration device,

FIG. 6 a detail view of the adapter,

FIG. 7 a further detail view of the adapter in accordance with FIG. 6,

FIG. 8 a schematic overview of the transceiver system,

FIG. 9 a schematic method flow diagram illustrating a method for operating the transceiver interface,

FIG. 10 a transceiver system having a transceiver interface, an external unit and at least one transceiver in an alternative exemplary embodiment, and

FIG. 11 a schematic overview of the transceiver system of the alternative exemplary embodiment according to FIG. 10.

### DESCRIPTION OF THE EXEMPLARY EMBODIMENTS

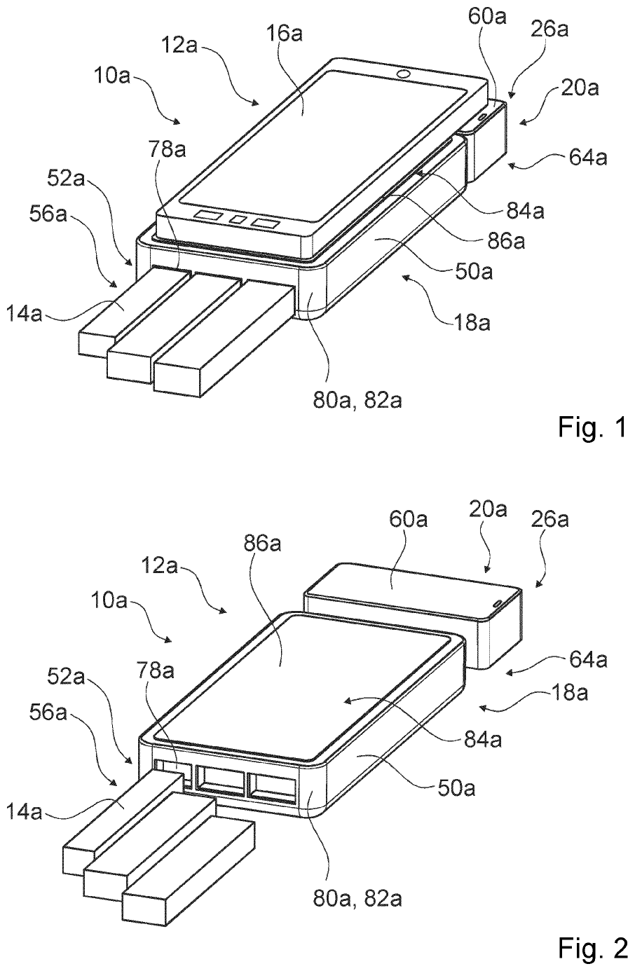

FIG. 1 shows a transceiver system 10a having a transceiver interface 12a, an external unit 16a and at least one transceiver 14a. The transceiver system 10a is implemented as an optical transceiver system and is designed to configure and/or reconfigure the transceiver 14a. The transceiver system 10a in this case is an SFP transceiver system. Alternatively and/or additionally, the transceiver system 10a could be a CFP, an OSFP, an XFP, a QSFP and/or a QSFP-DD transceiver system. The transceiver system 10a provides at least one data transmission system and/or communication system for the external unit 16a, the transceiver interface 12a and/or at least the transceiver 14a. In the present case, three transceivers 14a are shown by way of example, wherein only one transceiver is provided with a reference sign and the following description refers to this transceiver as an example. The transceiver 14a is a pluggable transceiver. The transceiver 14a could be a CFP, XFP, OSFP, QSFP, or QSFP-DD transceiver. In the present exemplary embodiment, the transceiver 14a is implemented as an SFP transceiver. The transceiver interface 12a comprises a transceiver interface 52a (cf. FIGS. 1 to 3 and 8). In this case, the transceiver interface 52a has at least one wire-bound transceiver communication unit 56a for wire-bound communication between the transceiver interface 12a and the transceiver 14a (cf. FIGS. 1 to 3 and 8). The wire-bound transceiver communication unit 56a comprises at least one transceiver slot 78a for at least the transceiver 14a (cf. FIGS. 1 to 3). In the present case, the wire-bound transceiver communication unit 56a comprises, for example, three transceiver slots, wherein in the interests of clarity, only one transceiver slot is provided with a reference sign. The transceiver 14a can be connected to the transceiver interface 12a in a reversible, releasable, specifically non-destructively reversible, manner. In the present case, the transceiver 14a can be plugged into the transceiver interface 12a. In contrast to FIG. 2, FIG. 1 shows a connected state, specifically a plugged-in state, in which at least the transceiver 14a is connected to the transceiver interface 12a, namely in the present case plugged into the transceiver interface 12a by means of the transceiver slot 78a. In the plugged-in state, the transceiver 14a can communicate with the transceiver interface 12a via the transceiver interface 52a. FIG. 2 shows an unconnected state, in which at least the transceiver 14a is arranged separately from the transceiver interface 12a.

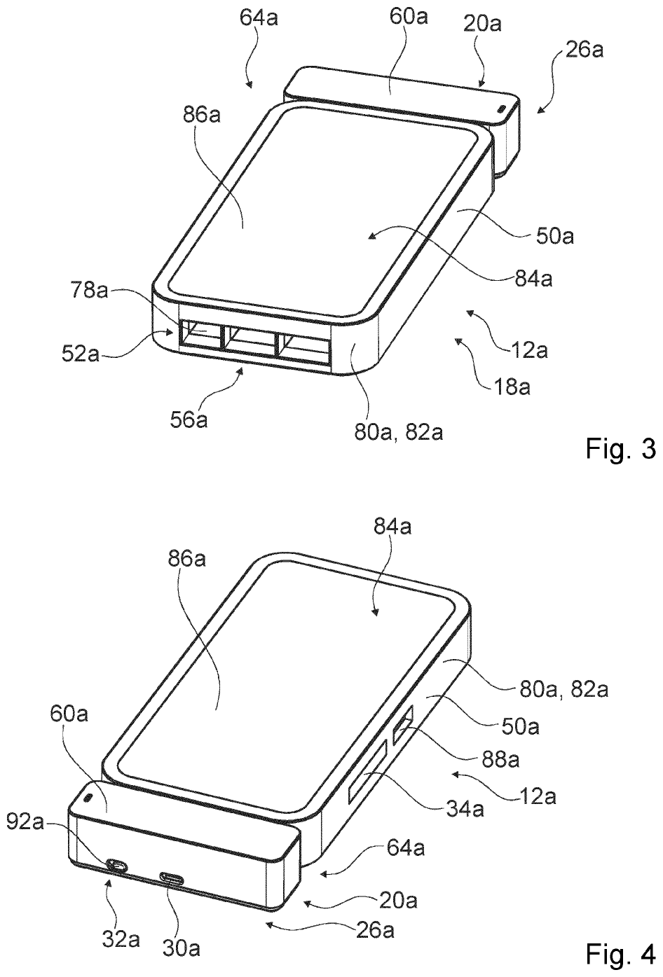

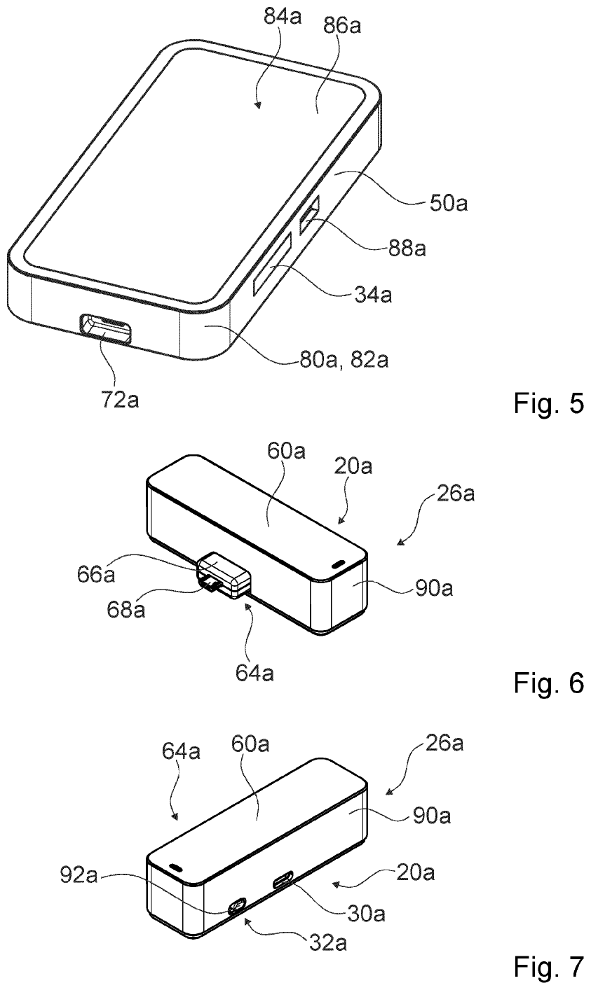

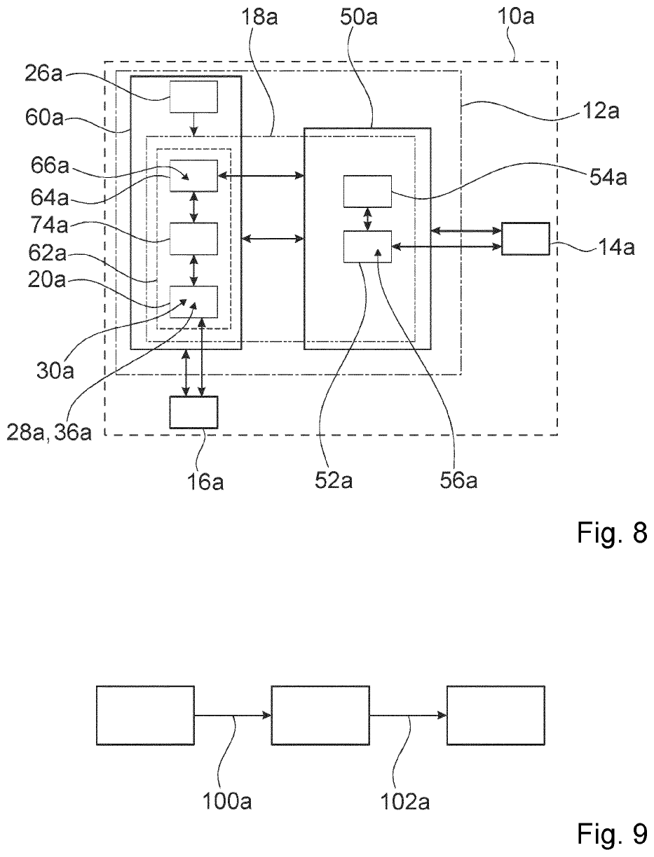

For better clarity and illustration of the association of the units and elements as well as the interaction of the units and elements with one another, a schematic overview of the transceiver system 10a is shown in FIG. 8. FIGS. 3 and 4 each show detail views of the transceiver interface 12a with an adapter 60a and a transceiver configuration device 50a in the plugged-in state. FIG. 5 shows a detail view of the transceiver configuration device 50a. The detail views of the adapter 60a according to FIGS. 6 and 7 illustrate the structure of the adapter 60a. In FIG. 9, a schematic method flow diagram shows an example of a method for operating the transceiver interface 12a.

In this case, the transceiver interface is a mobile transceiver interface 12a. The transceiver interface 12a comprises the transceiver configuration device 50a (cf. FIGS. 1 to 4 and 8). The transceiver configuration device 50a is designed for configuring the transceiver 14a. In order to provide a high flexibility and increased convenience, the transceiver configuration device 50a is implemented as a mobile handheld device (cf. FIGS. 1 to 5). In the present case, the transceiver configuration device 12a comprises the wire-bound transceiver communication unit 56a, specifically at least the transceiver slot 78a. In the plugged-in state, at least the transceiver 14a is plugged into the transceiver configuration device 50a, namely via the transceiver slot 78a (cf. FIG. 1).

In an operating state, the transceiver interface 52a provides a configuration connection between the transceiver configuration device 50a and the transceiver 14a. Alternatively and/or additionally, the transceiver interface 52a provides a user data connection to the transceiver 14a in the operating state. The user data connection here is an Internet connection, preferably a high-speed Internet connection.

The transceiver configuration device 50a has a device housing 80a (cf. FIGS. 1 to 5). At least the transceiver interface 52a is arranged in the device housing 80a. The device housing 80a is configured in this case as an external housing 82a. The device housing 82a has a holding unit 84a, which is designed for holding the external unit 16a (cf. FIGS. 1 to 5). The holding unit 84a is designed at least substantially flat. A main extension plane of the holding unit 84a is arranged at least substantially parallel to a main extension plane of the device housing 80a. The holding unit 84a is formed integrally with a top wall of the device housing 80a. In the present case, the holding unit 84a is materially bonded to the top wall of the device housing 80a. The external unit 16a can be at least partially placed on top of the holding unit 84a. FIG. 1 shows an arranged state of the external unit 16a, in which the external unit 16a rests at least partially on the holding unit 84a. To increase the static friction, namely in the region of a contact area with the external unit 16a, the holding unit 84a has at least one static friction element 86a (cf. FIGS. 1 to 5).

The external unit 16a is an electronic external device which is designed as an operating unit and/or control unit and is designed for controlling the transceiver interface 12a, preferably the transceiver configuration device 50a, and/or for configuring the transceiver 14a. For example, the external unit 16a is designed as a mobile terminal, in the present case as a mobile phone (cf. FIG. 1). Alternatively, it could potentially also be a permanently installed computer.

To increase flexibility, particularly with regard to versatility in use with the external unit 16a, the transceiver interface 12a in this exemplary embodiment comprises the adapter 60a (cf. FIGS. 1 to 4). The adapter 60a is an accessory and/or retrofit part of the transceiver interface 12a, specifically for the transceiver configuration device 50a. The adapter 60a is designed for connection to at least the transceiver configuration device 50a. In the plugged-in state according to FIG. 1, the adapter 60a is connected to the transceiver configuration device 50a. In the unconnected state, the adapter 60a is arranged separately from the transceiver configuration device 50a (cf. FIG. 2). FIG. 1 shows that the external unit 16a is arranged at least partially on the adapter 60a in the arranged state, namely resting on the adapter 60a. In the present case, the external unit 16a covers at least 15% of the adapter 60a.

The adapter 60a has an adapter housing 90a (cf. FIGS. 6 and 7). The adapter housing 90a of the adapter 60a is designed in the present case in a cuboid shape. The adapter 60a has a longitudinal extension of not more than 200 mm. In the present case, the longitudinal extension is at least substantially 86 mm. The adapter 60a has a transverse extension of not more than 120 mm. In this exemplary embodiment, the adapter 60a, namely the outer housing 82a, has a transverse extension of 50 mm, wherein a transverse extension of 35 mm is also possible. The adapter 60a has a thickness of not more than 80 mm. In the present case, the thickness of the adapter 60a, namely the adapter housing 82a, is at least substantially 25 mm. The term “at least substantially” is intended to mean that a value and/or an orientation deviates by a maximum of 10%, advantageously by a maximum of 5% and preferably by a maximum of 1% from the described value and/or the described orientation.

For configuring the pluggable transceiver 14a, the transceiver interface 12a has a configuration unit 18a (cf. FIGS. 1 to 3 and 8). FIG. 8 shows that the configuration unit 18a is formed at least partially integrally with the transceiver configuration device 50a and the adapter 60a. In this case, the adapter 60a and the transceiver configuration device 50a together comprise the configuration unit 18a. The adapter 60a and the transceiver configuration device 50a comprise at least one unit and/or at least one element of the configuration unit 18a. To provide the autonomous power supply of at least the configuration unit 18a, the transceiver interface 12a has a power supply unit 26a (cf. FIGS. 1 to 4 and 8). In the operating state the power supply unit 26a provides an autonomous power supply to at least the configuration unit 18a for at least 30 minutes. Thus, a power supply to at least the configuration unit 18a can be provided independently of an external power supply source, for example the external unit 16a. In this embodiment, the adapter 60a comprises the power supply unit 26a for the autonomous power supply of at least the configuration unit 18a (cf. FIGS. 1 to 4 and 6 to 8).

At least for programming the transceiver 14a, the transceiver configuration device 50a comprises a configuration element 54a of the configuration unit 18a (cf. FIG. 8). The power supply unit 26a is additionally provided for the autonomous power supply of at least the configuration element 54a. The configuration element 54a allows the transceiver 14a to be configured. The transceiver 14a can be programmed and/or tuned and/or tested, for example, in the operating state. In the operating state, the configuration element 54a receives a configuration command and/or a control command from the external unit 16a for configuring the transceiver 14a. In the present case, the configuration element 54a is controlled directly by means of a browser executable on the external unit 16a.

The configuration unit 18a has a communication interface 20a for communication with the external unit 16a (cf. FIGS. 1 to 4 and 8). The communication interface 20a communicates with the external unit 16a by means of a first communication protocol. The communication interface 20a comprises a wireless communication unit 28a for wireless communication with the external unit 16a (cf. FIG. 8). The wireless communication unit 28a is designed to provide, for example, an infrared connection, a WLAN connection, a radio connection, an NFC connection, a Bluetooth connection, a ZigBee connection and/or a wireless USB connection between the external unit 16a and the transceiver interface 12a, in this case between the external unit 16a and at least the adapter 60a. In this embodiment, the wireless communication unit 28a is configured as a WPAN communication unit 36a (cf. FIG. 8). In the operating state the WPAN communication unit 36a provides at least one Bluetooth connection for communication between the external unit 16a and the configuration unit 18a. In the present case, the external unit 16a communicates at least with the adapter 60a by means of the WPAN communication unit 36a in the operating state (cf. FIG. 8).

For alternative communication of the external unit 16a with the transceiver interface 12a, the communication interface 20a has at least one wire-bound communication unit 30a, namely a USB communication unit for wire-bound communication with the external unit 16a (cf. FIG. 8). The wire-bound communication unit 30a forms part of the transceiver interface 12a. In the present case, the adapter 60a comprises the wire-bound communication unit 30a, namely the USB communication unit (cf. FIGS. 4 and 7). In this example, the USB communication unit is designed as a USB-C communication unit. A USB-C plug of the external unit 16a can be inserted into the USB-C communication unit in the form of a USB-C plug socket to enable communication between the external unit 16a and the transceiver interface 12a. In at least the operating state, the communication between the external unit 16a and the transceiver interface 12a, in this case at least the adapter 60a, can take place by means of the wire-bound communication unit 30a. The communication interface 20a has an additional wire-bound communication unit 88a. The further wire-bound communication unit 88a is part of the transceiver configuration device 50a (cf. FIG. 5). In at least the operating state, the communication between the external unit 16a and the transceiver interface 12a, in this case at least the transceiver configuration device 50a, can take place by means of the additional wire-bound communication unit 88a. In addition, the power supply unit 26a is provided for the autonomous power supply of at least the external unit 16a.

The adapter 60a has an adapter unit 62a, wherein the adapter unit 62a is part of the configuration unit 18a (cf. FIG. 8). The adapter unit 62a in the present case comprises the communication interface 20a for communication with the external unit 16a. In this exemplary embodiment, the configuration unit 18a communicates with the external unit 16a by means of the wireless communication unit 28a in the operating state. In the present case, the adapter 60a comprises the power supply unit 26a for the autonomous power supply of at least the adapter unit 62a.

So that the adapter 60a can communicate with the transceiver configuration device 50a, the adapter unit 62a has an adapter interface 64a (cf. FIGS. 1 to 4 and 6 to 8). In this case, to enable wire-bound communication with the transceiver configuration device 50a, the adapter interface 64a has at least one wire-bound adapter communication unit 66a, which is designed, for example, as a USB adapter communication unit (cf. FIGS. 6 and 8). FIG. 6 illustrates that the wire-bound adapter communication unit 66a has a plug connector element 68a, which can be connected directly to the transceiver configuration device 50a. The USB adapter communication unit in this case is a micro-USB adapter communication unit, wherein the plug connector element 68a is configured as a micro-USB plug connector. The plug connector element 68a can be plugged into a mating socket 72a of the transceiver configuration device 50a, in the present case into a micro-USB mating socket of the transceiver configuration device 50a. The mating plug socket 72a of the transceiver configuration device 50a is recessed in the device housing. The adapter 60a can be connected to the transceiver configuration device 50a by means of the plug connector element 68a in a reversible, in particular releasable, and preferably non-destructively releasable manner, namely preferably able to be plugged into the transceiver interface 50a. In the plugged-in state, the wire-bound adapter communication unit 66a is directly connected by means of the plug connector element 68a to the transceiver configuration device 50a (cf. FIGS. 1, 3 and 4). By means of the adapter interface 64a, in the plugged-in state and in the operating state the adapter 60a communicates with the transceiver configuration device 50a by means of a second communication protocol.

The adapter unit 62a comprises a converter unit 74a, which is designed to enable communication between the external unit 16a and at least the adapter 60a. The converter unit 74a also allows communication between the adapter 60a and the transceiver configuration device 50a. The converter unit 74a is designed for converting between the first communication protocol and the second communication protocol. In this case, the converter unit 74a converts communication by means of the first communication protocol or the second communication protocol into communication by means of the second communication protocol or the first communication protocol.

The wireless communication link can be optionally switchable on and off. The transceiver interface 12a, in this case the adapter 60a, has an operating element 92a which is designed at least for activating the wireless communication link to the external unit 16a (cf. FIGS. 4 and 7). By means of the operating element 92a, at least one operating mode of the operating state can be set. The operating state has a plurality of operating modes. The operating element 92a in this case can be moved between at least three positions.

The configuration unit 18a has a display unit 32a, which is designed for displaying at least one operating status. In this case the display unit 32a is part of the adapter 60a (cf. FIGS. 4 and 7). The display unit 32a is integrated in the operating element 92a.

The operating state has a plurality of operating modes. The display unit 32a is designed for displaying at least one operating status with respect to at least one operating mode of the operating modes. In a first operating mode of the operating modes, for communication with the transceiver interface 12a the external unit 16a is connected by means of the wire-bound communication unit 30a to the transceiver interface 12a, namely the adapter 60a (not shown). The data transmission and/or communication between the external unit 16a and the transceiver interface 12a in the first operating mode is wire-bound, namely passive. In addition, in the first operating mode the external unit 16a can supply at least the configuration unit 18a with power, namely by means of the wire-bound communication unit 30a. In addition, the external unit 16a can charge the power supply unit 26a with power in the first operating mode. In this exemplary embodiment, the display unit 32a indicates the first operating mode with yellow-colored light (not shown).

The display unit 32a indicates a second operating mode of the operating modes, for example, by a blue color (not shown). In the second operating mode, for communication with the transceiver interface 12a, namely the configuration unit 18a, the external unit 16a is connected via the wire-bound communication unit 30a to the transceiver interface 12a (not shown). In the second operating mode, the power supply unit 26a provides the autonomous power supply, preferably independently of the external unit 16a, of at least the configuration unit 18a.

To distinguish a third operating mode of the operating modes from at least the first operating mode and/or the second operating mode, the display unit 32a lights up green in the third operating mode. In the present case, the operating state in the third operating mode is shown in FIG. 1. In at least the third operating mode, the power supply unit 26a provides the autonomous power supply of at least the configuration unit 18a (cf. FIG. 8). In at least the third operating mode, the wireless communication unit 28a provides the wireless communication link for communication between the transceiver interface 12a and the external unit 16a (cf. FIG. 1). In this exemplary embodiment, the external unit 16a is connected by means of the Bluetooth connection to the transceiver interface 12a, namely the adapter 60a (cf. FIG. 1) in the third operating mode.

For internal operation and/or control of the configuration unit 18a, preferably independently of the external unit 16a, the transceiver interface 12a has an operator interface 34a (cf. FIGS. 4 and 5). This means that the control and/or operation by means of the external unit 16a may be omitted. In the operating mode, the power supply unit 26a supplies at least the operator interface 34a with power autonomously.

The method flow diagram shown schematically in FIG. 9 illustrates the method for operating the transceiver interface 12a. The method could comprise a plurality of method sub-steps. In the present case, the method for operating the transceiver interface 12a is illustrated in an exemplary manner by means of a first method step 100a and a second method step 102a. For communication with the external unit 16a, the external unit 16a is placed on the transceiver interface 12a in the first method sub-step 100a. The communication link is activated in the second method sub-step 102a. In this case, the power supply unit 26a is activated so that at least the configuration unit 18a is supplied with power autonomously by means of the power supply unit 26a. Thus, the wireless communication link between the external unit 16a and the transceiver interface 12a, in this case the adapter 60a, can be provided by means of the communication interface 20a, wherein the communication interface 20a is formed by the WPAN communication unit 36a for wireless communication with the external unit 16a.

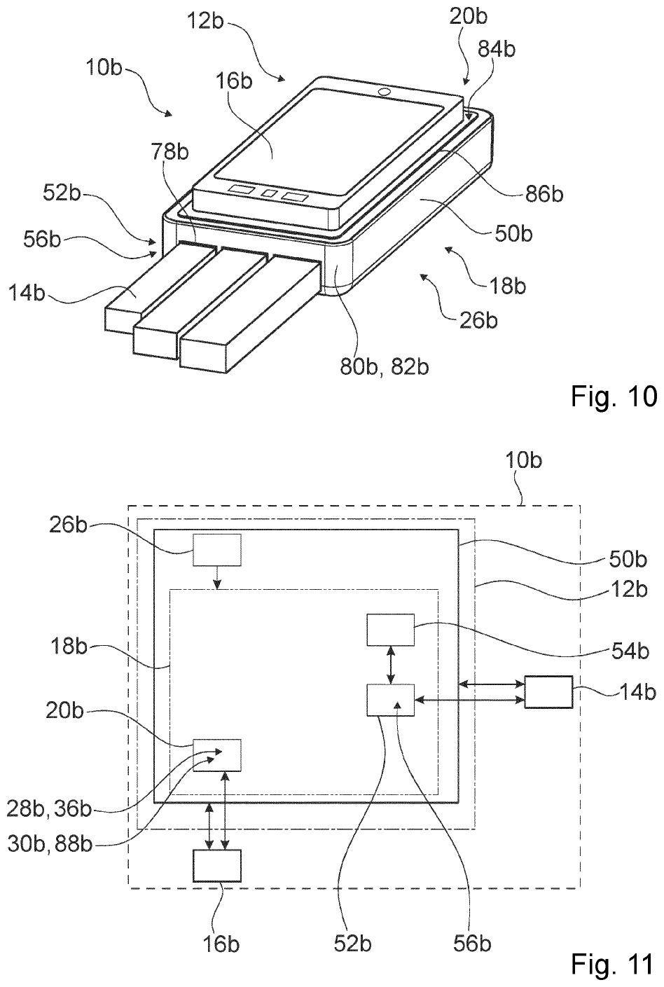

FIGS. 10 and 11 show a further exemplary embodiment of the invention. The following descriptions are limited essentially to the differences between the exemplary embodiments, wherein with regard to components, features, functions and method steps that are the same throughout, the description of the exemplary embodiment of FIGS. 1 to 9 can be referred to. To distinguish between the exemplary embodiments, the letter a in the reference signs of the exemplary embodiment in FIGS. 1 to 9 is replaced by the letter b in the reference signs of the exemplary embodiment of FIGS. 10 and 11. With respect to components with the same designation, in particular with respect to components with the same reference signs, reference can certainly also be made to the drawings and/or to the description of the exemplary embodiment of FIGS. 1 to 9.

FIG. 10 shows a transceiver system 10b having a transceiver interface 12b, an external unit 16b and at least one transceiver 14b. In this embodiment, the transceiver interface 12b is implemented as a transceiver configuration device 50b. A power supply unit 26b of the transceiver interface 12b for the autonomous power supply of at least one configuration unit 18b of the transceiver interface 12b is part of the transceiver configuration device 50b in the present case (cf. FIG. 11).

FIG. 10 shows that the external unit 16b is arranged at least partially on the transceiver configuration device 50b in the arranged state, namely resting on the transceiver configuration device 50b. In this case, the external unit 16b is resting completely on the transceiver configuration device 50b.

In the present case, a configuration unit 18b of a transceiver interface 12b is arranged completely in the transceiver configuration device 50b, wherein all the units and elements belonging to the configuration unit 18b are also part of the transceiver configuration device 50b. FIG. 11 shows, as an example, that a communication interface 20b of the configuration unit 18b for communication with the external unit 16b is part of the transceiver configuration device 50b. In at least one operating state, the external unit 16b communicates directly with the transceiver configuration device 50b, namely by means of the communication interface 20b arranged in the transceiver configuration device 50b. The communication interface 20b comprises a wire-bound communication unit 30b, which is identical to an additional wire-bound communication unit 88b of the communication interface 20b in the present case. In the operating state, the transceiver configuration device 50b can communicate with the external unit 16b by means of the wire-bound communication unit 30b.

The communication interface 20b comprises a wireless communication unit 28b for wireless communication with the external unit 16b. The wireless communication unit 28b is implemented as a WPAN communication unit 36b. In this embodiment, the external unit 16b communicates by means of the wireless communication unit 28b with at least the configuration unit 18b in the operating state (cf. FIGS. 10 and 11).

### REFERENCE SIGNS

10 transceiver system
12 transceiver interface
14 transceiver
16 external unit
18 configuration unit
20 communication interface
26 power supply unit
28 wireless communication unit
30 wire-bound communication unit
32 display unit
34 operator interface
36 WPAN communication unit
50 transceiver configuration device
52 transceiver interface
54 configuration element
56 transceiver communication unit
60 adapter
62 adapter unit
64 adapter interface
66 wire-bound adapter communication unit
68 plug connector element
72 mating plug socket
74 converter unit
78 transceiver slot
80 device housing
82 outer housing
84 holding unit
86 static friction element
88 wire-bound communication unit
90 adapter housing
92 operating element
100 first method step
102 second method step

1. A transceiver interface, in particular mobile transceiver interface, having a configuration unit for configuring a pluggable transceiver, which comprises a communication interface for communication with an external unit and a transceiver interface for communication with the transceiver, characterized by a power supply unit for the autonomous power supply of at least the configuration unit.

2. The transceiver interface according to claim 1, characterized in that the power supply unit provides an autonomous power supply of at least the configuration unit for at least 30 minutes.

3. The transceiver interface according to claim 1, characterized in that the communication interface comprises a wireless communication unit, in particular a WPAN communication unit, for wireless communication with the external unit.

4. The transceiver interface according to claim 1, characterized in that the transceiver interface is designed for providing a user data connection to the transceiver.

5. The transceiver interface according to claim 1, characterized in that the communication interface comprises at least one wire-bound communication unit, in particular a USB communication unit, for wire-bound communication with the external unit.

6. The transceiver interface according to claim 1, characterized by a transceiver configuration device, which comprises at least the transceiver interface and a configuration element of the configuration unit at least for programming the transceiver.

7. The transceiver interface according to claim 6, characterized in that the power supply unit is designed additionally for the autonomous power supply of at least the configuration element.

8. The transceiver interface according to claim 6, characterized by an adapter having an adapter unit, which comprises the communication interface and an adapter interface for communication with the transceiver configuration device.

9. The transceiver interface according to claim 8, characterized in that the adapter interface comprises at least one wire-bound adapter communication unit, in particular a USB adapter communication unit, for wire-bound communication with the transceiver configuration device.

10. The transceiver interface according to claim 9, characterized in that the wire-bound adapter communication unit has a plug connector element, which can be connected directly to the transceiver configuration device.

11. The transceiver interface according to claim 8, characterized in that the adapter comprises the power supply unit for the autonomous power supply of at least the adapter unit.

12. The transceiver interface according to claim 1, characterized in that the power supply unit is designed additionally for the autonomous power supply of at least the external unit.

13. The transceiver interface according to claim 1, characterized in that the configuration unit has a display unit which is designed for displaying at least one operating status.

14. The transceiver interface according to claim 1, characterized by an operator interface for operating and/or controlling the configuration unit.

15. The transceiver system having a transceiver interface according to claim 1, having the external unit and the transceiver.

16. A method for operating a transceiver interface, in particular according to claim 1, having an external unit for controlling the transceiver interface, wherein the transceiver interface comprises a configuration unit for configuring a transceiver with a communication interface for communication with the external unit, characterized in that at least the configuration unit is autonomously supplied with power.

17. The method according to claim 16, characterized in that the communication interface has a WPAN communication unit for wireless communication with the external unit and the external unit is placed at least partially on the transceiver interface.
